(19) United States
(12) Patent Application Publication
(10) Pub. No.: US 2026/0370269 A1
(43) Pub. Date: Nov. 19, 2026

(54) RADIO FREQUENCY FRONT-END DEVICE, RADIO FREQUENCY TRANSCEIVING SYSTEM, AND COMMUNICATION EQUIPMENT

(71) Applicant: GUANGDONG OPPO MOBILE TELECOMMUNICATIONS CORP., LTD., Dongguan (CN)

(72) Inventor: Xingrui ZHAO, Dongguan (CN)

(21) Appl. No.: 19/735,363

(22) Filed: Jul. 8, 2026

Related U.S. Application Data
(63) Continuation of application No. PCT/CN2023/138076, filed on Dec. 12, 2023.

(30) Foreign Application Priority Data
Jan. 18, 2023 (CN) 202310087977.0

(51) Int. Cl. H04B 7/0413; H04B 1/40

(52) U.S. Cl. CPC H04B 7/0413; H04B 1/40

(57) ABSTRACT

Provided are a radio frequency (RF) front-end device, an RF transceiver system, and a communication equipment, which are used for a high frequency band signal transmit path, a high frequency band signal receive path, and a middle frequency band signal receive path. The radio frequency front-end device is provided with a high frequency band transmit port, a first high frequency band receive port, a first middle frequency band receive port, a first antenna port, and a second antenna port. The radio frequency front-end device at least includes a first switch circuit, a first transceiver circuit, a first receive circuit, and a second transceiver circuit.

### CROSS-REFERENCING OF RELATED APPLICATIONS

This application is a continuation of International Patent Application No. PCT/CN2023/138076, filed Dec. 12, 2023, which claims priority to Chinese Patent Application No. 202310087977.0, filed Jan. 18, 2023, and the entire contents of which are incorporated herein by reference.

### TECHNICAL FIELD

The disclosure relates to the field of antenna technologies, and in particular to a radio frequency (RF) front-end device, an RF transceiver system and a communication equipment.

### BACKGROUND

The year 2019 is defined as the first year of the fifth-generation mobile communication technology (5G), at this year, major communication operators worldwide officially started the construction of 5G mobile communication networks. Considering the high cost of 5G standalone (SA) networking architecture, most operators at home and abroad choose to adopt non-standalone (NSA) networking architecture, i.e., EN-DC (4G, 5G dual connection), in the early stage.

In order to further improve spectrum efficiency, operators began to use refarming of SUB 3GHz, and SUB 1GHz with better coverage became the focus of many operators. Domestic operators require that mobile terminals priced at 2,000 yuan must support 5G refarming of the N41 frequency band and support the EN-DC combination of DC_B3-N41. Since this is a new requirement, the companies in the industry are designing their own RF front-end architectures.

### SUMMARY

Embodiments of the disclosure provide an RF front-end device, an RF transceiver system, and a communication equipment.

In a first aspect, the embodiments of the disclosure provide an RF front-end device. The RF front-end device is provided with a high frequency band transmit port, a first high frequency band receive port, a first middle frequency band receive port, a first antenna port, and a second antenna port. The RF front-end device at least includes a first switch circuit, a first transceiver circuit, a first receive circuit and a second transceiver circuit.

Multiple first terminals of the first switch circuit are respectively connected to the first transceiver circuit, the first receive circuit, and the second transceiver circuit; a second terminal of the first switch circuit is connected to the first antenna port, and is configured to selectively switch on an RF path between the first transceiver circuit and the first antenna port; another second terminal of the first switch circuit is connected to the second antenna port, the first switch circuit is capable of selectively switching on an RF path between the first receive circuit and the second antenna port, and the first switch circuit is further capable of selectively switching on an RF path between the second transceiver circuit and the second antenna port.

The first transceiver circuit is connected to the high frequency band transmit port, and is configured to perform power amplification on a high frequency band signal from the high frequency band transmit port and output a processed high frequency band signal through the first antenna port.

The first receive circuit is connected to the first high frequency band receive port, and is configured to perform filtering and power amplification on a signal received from the second antenna port, and output a high frequency band signal to the first high frequency band receive port.

The second transceiver circuit is connected to the first middle frequency band receive port, and is configured to perform filtering and power amplification on a signal from the second antenna port, and output a middle frequency band signal to the first middle frequency band receive port.

In a second aspect, the embodiments of the disclosure provide an RF transceiver system, which includes a first antenna, a second antenna, a third antenna, a fourth antenna, a radio frequency transceiver, an antenna switching module, a low noise front end module and a radio frequency front end device as described in the first aspect.

The radio frequency transceiver is connected to the first antenna via the radio frequency front-end device and the antenna switching module, thereby forming at least a primary transmit path for a high frequency band signal and a primary receive path for the high frequency band signal.

The radio frequency transceiver is connected to the second antenna via the radio frequency front-end device and the antenna switching module, thereby forming at least a primary multiple input multiple output receive path for the high frequency band signal, a primary receive path for a middle frequency band signal, and a primary transmit path for the middle frequency band signal.

The radio frequency transceiver is connected to the third antenna via the low noise front-end module and the antenna switching module, thereby forming at least a diversity receive path for the high frequency band signal and a diversity receive path for the middle frequency band signal.

The radio frequency transceiver is connected with the fourth antenna via the low noise front-end module and the antenna switching module, thereby forming at least a diversity multiple input multiple output receive path for the high frequency band signal.

The high frequency band signal is a signal of a preset high frequency band in a non-standalone mode, and the middle frequency band signal is a signal of a preset middle frequency band in the non-standalone mode.

In a third aspect, the embodiments of the disclosure provide a communication equipment, including the radio frequency transceiver system as described in the second aspect.

### BRIEF DESCRIPTION OF THE DRAWINGS

FIG. 1A is a schematic diagram of an architecture of a Middle and High frequency bands (also referred to as Mid-High band or MHB) L-PAMiD device according to some embodiments of the disclosure.

FIG. 1B is a schematic diagram of an architecture of another MHB L-PAMiD device according to some embodiments of the disclosure.

FIG. 2A is a schematic diagram of an architecture of an RF front-end device according to some embodiments of the disclosure.

FIG. 2B is a schematic diagram of an architecture of another RF front-end device according to some embodiments of the disclosure.

FIG. 3 is a schematic diagram of an architecture of yet another RF front-end device according to some embodiments of the disclosure.

FIG. 4 is a schematic diagram of an architecture of still another RF front-end device according to some embodiments of the disclosure.

FIG. 5 is a schematic diagram of an architecture of still yet another RF front-end device according to some embodiments of the disclosure.

FIG. 6 is a schematic diagram of an architecture of still yet another RF front-end device according to some embodiments of the disclosure.

FIG. 7 is a schematic diagram of an architecture of still yet another RF front-end device according to some embodiments of the disclosure.

FIG. 8A is a schematic diagram of an architecture of an RF front-end system according to some embodiments of the disclosure.

FIG. 8B is a schematic diagram of an architecture of another RF front-end system according to some embodiments of the disclosure.

FIG. 9A is a schematic diagram of an architecture of yet another RF front-end system according to some embodiments of the disclosure.

FIG. 9B is a schematic diagram of an architecture of still another RF front-end system according to some embodiments of the disclosure.

### DETAILED DESCRIPTION OF PREFERRED EMBODIMENTS

In order to make the objectives, technical solutions and advantages of the disclosure more clear, the embodiments of the disclosure will be described in detail below with reference to the accompanying drawings. It is notable that the embodiments and features in the embodiments of the disclosure can be combined with each other arbitrarily without conflict.

In order to facilitate understanding of the disclosure, the disclosure will be described more comprehensively below with reference to the relevant drawings. Embodiments of the disclosure are provided in the drawings. However, the disclosure can be implemented in many different forms and is not limited to the embodiments described herein. On the contrary, the purpose of providing these embodiments is to make the disclosure of the disclosure more thorough and comprehensive.

Unless otherwise defined, all technical and scientific terms used herein have the same meaning as those commonly understood by those skilled in the art to which the disclosure belongs. The terms used herein in the specification of the disclosure are only for the purpose of describing specific embodiments and are not intended to limit the disclosure.

It can be understood that terms “first”, “second” and the like used herein is only for the purpose of description, and cannot be understood as indicating or implying relative importance or implicitly indicating the number of indicated technical features. Therefore, the feature preceded by “first”, “second” or the like may explicitly or implicitly include at least one of the features. In the description of the disclosure, the term “a plurality of” means at least two, such as two, and three, unless otherwise specifically defined.

It can be understood that, regarding “connection/connected” used in the following embodiments, when there is transmission of electrical signal or data between the connected circuits, modules, units, etc., the “connection/connected” should be understood as “electrical connection”, “communication connection”, etc.,

As used herein, the singular forms “a/an”, “one”, and “the” may further include plural forms unless the context clearly indicates otherwise. It should also be understood that the terms “comprise/include” or “have” and the like specify the existence of stated features, entities, steps, operations, components, parts, or combinations thereof, but do not exclude the existence or addition of one or more other features, entities, steps, operations, components, parts, or combinations thereof. In addition, the term “and/or” used herein includes any and all combinations of the related listed items.

The embodiments of the disclosure involve device of RF Power Amplifier Modules including Duplexers with low noise amplifier (LNA), which is also referred to as LNA-Power Amplifier Module Integrated Duplexer, and is abbreviated to L-PAMiD. The device may be applied to a communication equipment with wireless communication capabilities. The communication equipment may be a handheld equipment, a vehicle-mounted equipment, a wearable equipment, a computing equipment, or other processing equipment connected to a wireless modem, various user equipment (UE) such as a mobile phone, a mobile station (MS), or a network equipment. For purposes of description, the above-mentioned devices are collectively referred to as the communication device. The network equipment may include a base station, an access point, etc.

The NSA mode may include any of the following architectures: EN-DC, NE-DC, NGEN-DC, etc. Specifically, DC represents dual connectivity; E represents E-UTRA, i.e., 4G radio access network; N represents NR, i.e., 5G New Radio; NG represents Next Generation Core Network, i.e., 5G core network.

In the EN-DC architecture, the core network is the 4G core network, the 4G base station is the main station, the 5G base station is the auxiliary station, and EN-DC refers to the dual connectivity with the 4G radio access network and the 5G NR. In the NE-DC architecture, the core network is the 5G core network, the 5G base station is the main station, the 4G base station is the auxiliary station, and NE-DC refers to the dual connectivity with the 5G NR and the 4G radio access network. In the NGEN-DC architecture, the core network is the 5G core network, the 4G base station is the main station, the 5G base station is the auxiliary station, and NGEN-DC refers to the dual connectivity with the 4G radio access network and the 5G NR under the 5G core network.

For ease of illustration, in the embodiments of the disclosure, the NSA mode is described by taking the EN-DC architecture as an example.

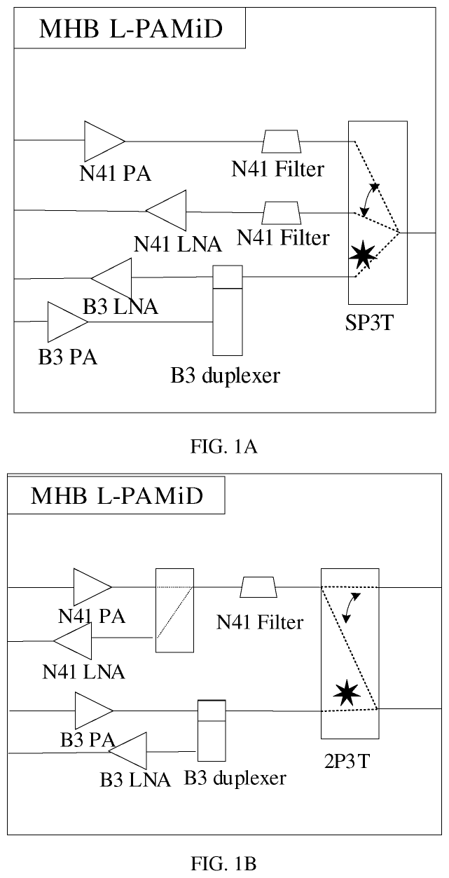

FIG. 1A and FIG. 1B are schematic diagrams of an existing Middle and High frequency band (also referred to as Mid-High band, and abbreviated to MHB) L-PAMiD device of an RF transceiver system in the related art provided by some embodiments of the disclosure, in which PA denotes a power amplifier, LNA denotes a low noise amplifier, and Filter denotes a filter. In the MHB L-PAMiD device, a B3 band signal receive path and a N41 band signal receive path achieve carrier aggregation (CA) based on multi-on technology. Because the N41 band operates in a time division duplex (TDD) operating mode, when the N41 band is switched between a transmit mode and a receive mode, a switch device in the MHB L-PAMiD device would perform a contact switching operation (a contact switching state is indicated by a bidirectional arrow in FIG. 1A and FIG. 1B). Since a N41 transmit path and the N41 receive path share a common contact, the contact switching operation would cause discontinuity of the internal impedance of the switch device, which would further lead to deterioration of throughput or EVM of the B3 receive path (the path marked with a star in FIG. 1A and FIG. 1B).

In view of this, the embodiments of the disclosure provide an RF front-end device, which aims to solve the problem of the deterioration of throughput or EVM by optimizing the impedance discontinuity issue.

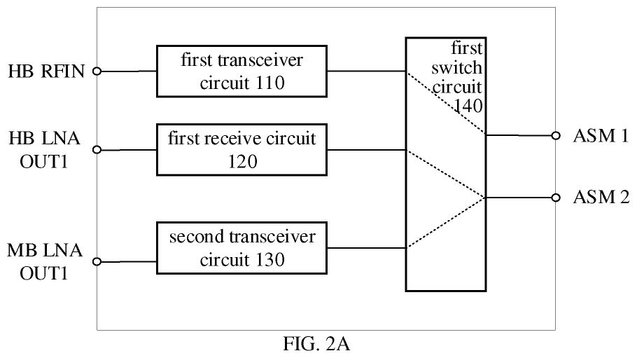

FIG. 2A is a structural schematic diagram of an RF front-end device according to some embodiments of the disclosure. The RF front-end device is provided with a high frequency band (also referred to as High-band or HB) transmit port HB RFIN, a first high frequency band receive port HB LNA OUT1, a first middle frequency band (also referred to as Mid-band or MB) receive port MB LNA OUT1, a first antenna port ASM1, and a second antenna port ASM2. The RF front-end device at least includes a first switch circuit 140, a first transceiver circuit 110, a first receive circuit 120 and a second transceiver circuit 130.

Multiple first terminals of the first switch circuit 140 are respectively connected to the first transceiver circuit 110, the first receive circuit 120, and the second transceiver circuit 130. A second terminal of the first switch circuit 140 is connected to the first antenna port ASM1, and the first switch circuit 140 is configured to selectively switch on an RF path between the first transceiver circuit 110 and a first antenna (which is also referred to as selectively making this RF path be in an on state/conductively connected). Another second terminal of the first switch circuit 140 is connected to the second antenna port ASM2, and the first switch circuit 140 is capable of selectively switching on an RF path between the first receive circuit 120 and a reference antenna, and is further capable of selectively switching on an RF path between the second transceiver circuit 130 and the reference antenna. The reference antenna is the first antenna or a second antenna.

Specifically, the first antenna port ASM1 is configured to connect to a first terminal of an antenna switch module ASM, the second antenna port ASM2 is configured to connect to another first terminal of the antenna switch module ASM, and four second terminals of the antenna switch module ASM are configured to connect to four antennas, respectively. The first antenna is one of the four antennas, and the second antenna is an antenna other than the first antenna among the four antennas. Alternatively, the first antenna port ASM1 is configured to be directly connected to the first antenna without being connected via the antenna switch module ASM, and the second antenna port ASM2 is configured to be directly connected to the second antenna without being connected via the antenna switch module ASM.

FIG. 2B illustrates a schematic diagram of an architectural of another RF front-end device. In FIG. 2B, multiple first terminals of the first switch circuit 140 may include three first terminals, which are contact 1, contact 2, and contact 3, respectively; and multiple second terminals of the first switch circuit 140 may include two second terminals, which are contact 4 and contact 5, respectively. Contact 1 and contact 4 are capable of being selectively connected, each of contacts 2 and 3 is capable of being selectively connected with contact 5. Furthermore, the first transceiver circuit 110 is connected to contact 1, the first receive circuit 120 is connected to contact 2, the second transceiver circuit 130 is connected to contact 3, contact 4 is connected to the first antenna port ASM1, and contact 5 is connected to the second antenna port ASM2.

The first switch circuit 140 is a 2P3T switch.

The RF front-end device is an MHB L-PAMiD device.

The high frequency band transmit port HB RFIN is configured to connect to a high frequency band signal transmit port of an RF transceiver, the first high frequency band receive port HB LNA OUT1 is configured to connect to a high frequency band signal receive port of the RF transceiver, and the first middle frequency band receive port MB LNA OUT1 is configured to connect to a middle frequency band signal receive port of the RF transceiver. The first transceiver circuit 110 is connected to the high frequency band transmit port HB RFIN, and is configured to perform power amplification on a high frequency band signal from the high frequency band transmit port HB RFIN and output a processed high frequency band signal through the first antenna port ASM1.

The high frequency band signal is a signal of a preset high frequency band in the NSA mode, and the preset high frequency band includes one of N41 band, and N40 band.

The first receive circuit 120 is connected to the first high frequency band receive port HB LNA OUT1, and is configured to perform filtering and power amplification on a signal received from the second antenna port ASM2 and output a high frequency band signal to the first high frequency band receive port HB LNA OUT1.

The second transceiver circuit 130 is connected to the first middle frequency band receive port MB LNA OUT1, and is configured to perform filtering and power amplification on a signal from the second antenna port ASM2, and output a middle frequency band signal to the first middle frequency band receive port MB LNA OUT1.

The middle frequency band signal is a signal of a preset middle frequency band in the NSA mode, and the preset middle frequency band signal includes one of B3 band and B1 band.

The RF front-end device may further include a controller. The controller is connected to each of various switch circuits, various power amplifiers, various low noise amplifiers, and other components of the RF front-end device. The controller is configured to control on/off states of each switch circuit, control an operating state of the various power amplifiers, and adjust gain coefficients of the various low noise amplifiers. The controller may be a Mobile Industry Processor Interface (MIPI)-RF Front End Control Interface (RFFE) control unit or an RFFE control unit, which conforms to the control protocol of the RFFE bus. When the controller is the MIPI-RFFE control unit or the RFFE control unit, the RF MHB L-PAMiD device is further provided with a clock signal input pin CLK, a unidirectional/bidirectional data signal input or a bidirectional pin SDATAS, a power supply pin VDD, a reference voltage pin VIO, and the like, so as to realize control of the various power amplifiers, the various switch units, and the low noise amplifier in the RF front-end device.

It can be seen that, in the embodiments of the disclosure, since the high frequency band signal transmit path corresponding to the first transceiver circuit and the high frequency band signal receive path corresponding to the first receive circuit have no common contact in the first switch circuit, the first switch circuit can selectively perform switching between a transmit state and a receive state of the high frequency band signal without causing a problem of impedance discontinuity. As such, this can avoid the deterioration of throughput or EVM of the middle frequency band signal receive path corresponding to the second transceiver circuit, so that the high frequency band signal receive path and the middle frequency band signal receive path can both maintain the stable multi-on state to achieve CA in the receive state.

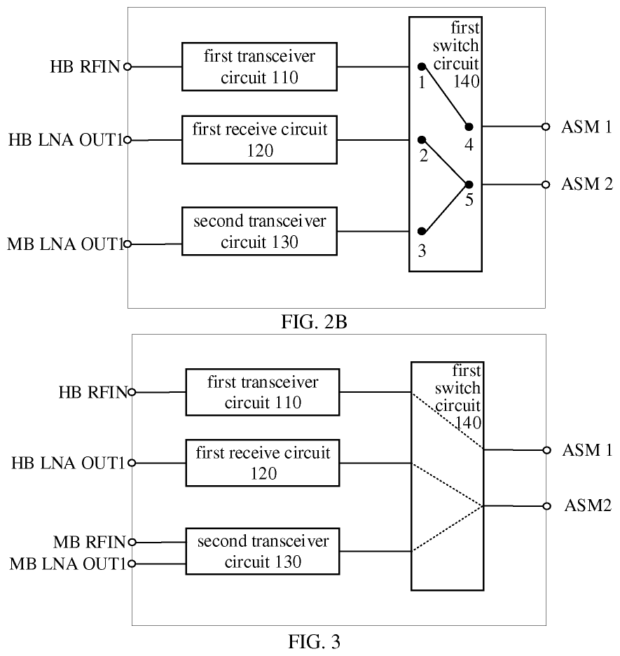

FIG. 3 illustrates a schematic diagram of an architecture of yet another RF front-end device according to a possible example, in which the RF front-end device is further provided with a middle frequency band transmit port MB RFIN.

The second transceiver circuit 130 is further connected to the middle frequency band transmit port MB RFIN, and is configured to perform power amplification on a middle frequency band signal from the middle frequency band transmit port MB RFIN, and output a processed middle frequency band signal through the second antenna port ASM2.

Specifically, the middle frequency band transmit port MB RFIN is configured to connect to a transmit port for middle frequency band signals of the RF transceiver.

It can be seen that, in this example, the RF front-end device may further integrate a transmit path for middle frequency band signals, this can eliminate the need to include two chips supporting transmission of high frequency band signals and middle frequency band signals respectively, thereby improving the integration level of the RF front-end device.

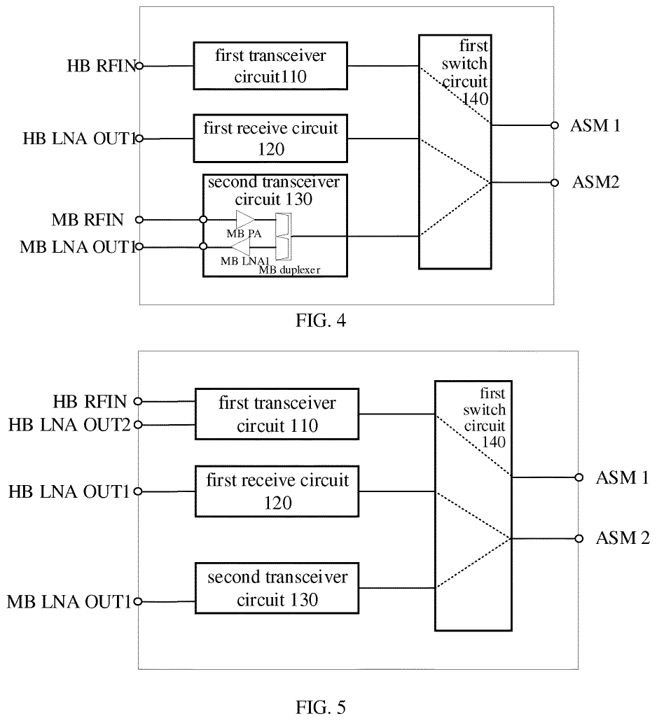

FIG. 4 illustrates a schematic diagram of an architecture of still another RF front-end device according to a possible example, the second transceiver circuit 130 includes a middle frequency band power amplifier (illustrated as MB PA in FIG. 4), a first low noise amplifier (illustrated as MB LNA1 in FIG. 4) and a middle frequency band duplexer.

The middle frequency band transmit port MB RFIN is connected to an input terminal of the middle frequency band power amplifier, and an output terminal of the middle frequency band power amplifier is connected to a first terminal of the middle frequency band duplexer.

Another first terminal of the middle frequency band duplexer is connected to an input terminal of the first low noise amplifier, and an output terminal of the first low noise amplifier is connected to the first middle frequency band receive port MB LNA OUT1.

A second terminal of the middle frequency band duplexer is connected to the first terminal of the first switch circuit.

It can be seen that, in this example, the RF front-end device realizes the transmit path and the receive path for the middle frequency band signal through the duplexer, the power amplifier, and the low noise amplifier.

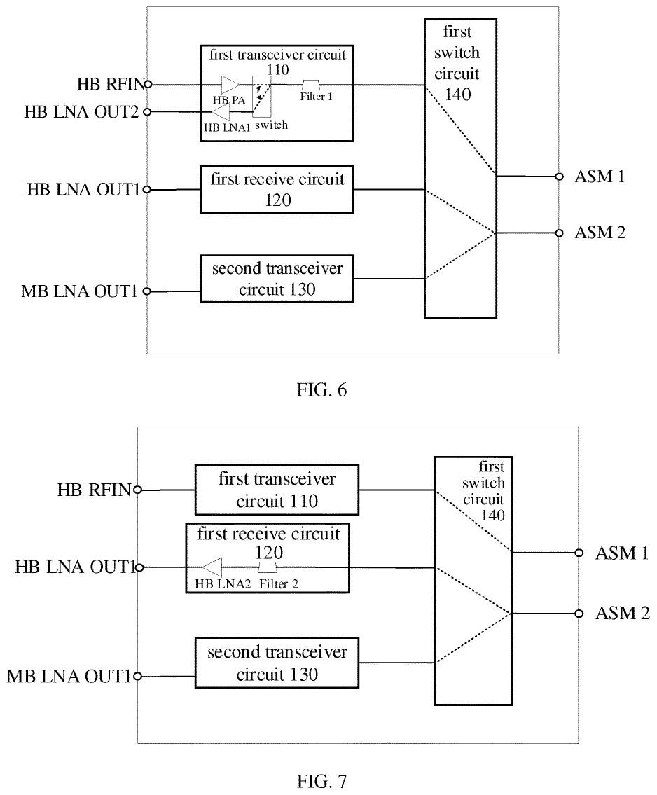

FIG. 5 illustrates a schematic diagram of an architecture of still yet another RF front-end device according to a possible example, in which the RF front-end device is further provided with a second high frequency band receive port HB LNA OUT2.

The first transceiver circuit 110 is further connected to the second high frequency band receive port HB LNA OUT2, and the first transceiver circuit is configured to perform filtering and power amplification on a signal received from the first antenna port ASM1, and output the high frequency band signal to the second high frequency band receive port HB LNA OUT2.

Specifically, the second high frequency band receive port HB LNA OUT2 is configured to connect to any receive port for high frequency band of the RF transceiver.

It can be seen that, in this example, the RF front-end device may integrate two high frequency band signal receive paths, and the two high frequency band signal receive paths have no common contact in the switch.

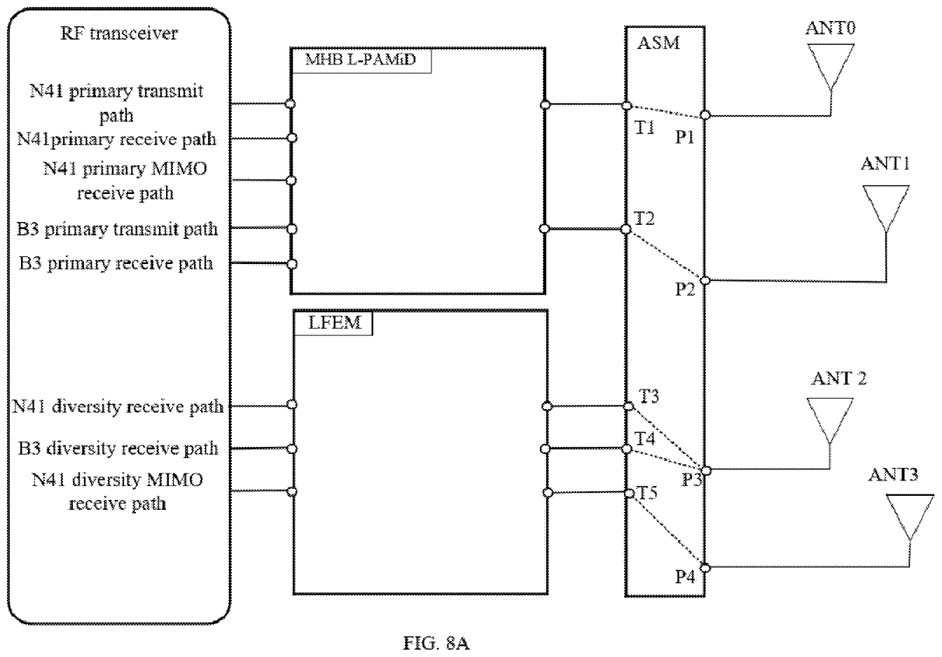

FIG. 6 illustrates a schematic diagram of an architecture of still yet another RF front-end device according to a possible example, in which the first transceiver circuit 110 includes a high frequency band power amplifier, a first high frequency band low noise amplifier, a switch, and a first filter.

The high frequency band transmit port HB RFIN is connected to an input terminal of the high frequency band power amplifier, and an output terminal of the high frequency band power amplifier is connected to a first terminal of the switch.

Another first terminal of the switch is connected to an input terminal of the first high frequency band low noise amplifier, and an output terminal of the first high frequency band low noise amplifier is connected to the second high frequency band receive port HB LNA OUT2.

A second terminal of the switch is connected to one terminal of the first filter, and another terminal of the first filter is connected to the first terminal of the first switch circuit.

Specifically, the switch is an SPDT switch, the two first terminals are respectively a first T port and a second T port, and the single second terminal is an S port.

It can be seen that, in this example, the RF front-end device can realize reception and transmission of high frequency band signals through the high frequency band power amplifier, the first high frequency band low noise amplifier, the switch, and the first filter.

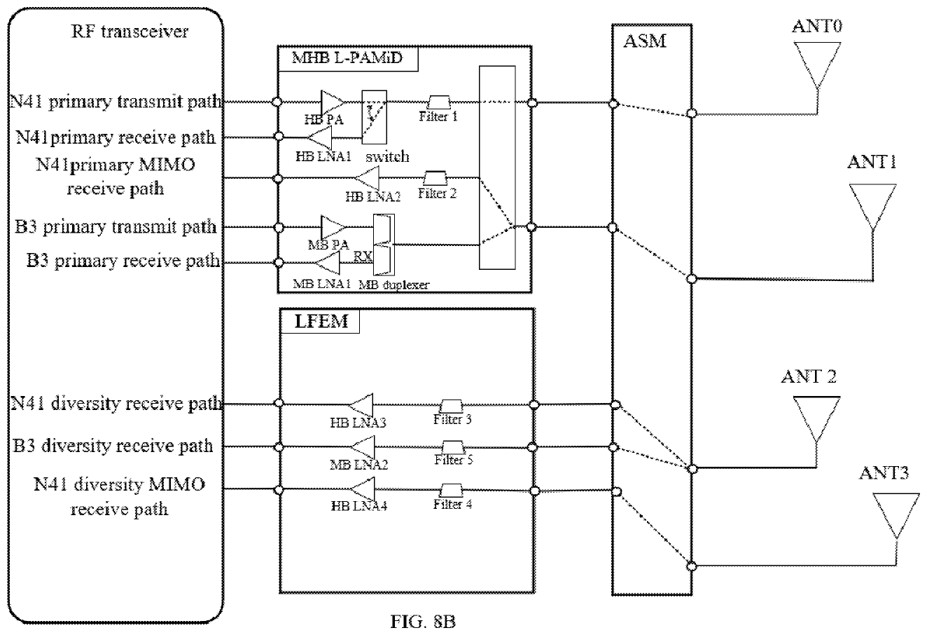

FIG. 7 illustrates a schematic diagram of an architecture of still yet another RF front-end device according to a possible example, in which the first receive circuit includes a second low noise amplifier (illustrated as HB LNA2 in FIG. 7) and a second filter (illustrated as Filter2 in FIG. 7).

The first high frequency band receive port HB LNA OUT1 is connected to an output terminal of the second low noise amplifier, an input terminal of the second low noise amplifier is connected to a first terminal of the second filter, and a second terminal of the second filter is connected to one first terminal of the first switch circuit.

It can be seen that, in this example, the RF front-end device can realize reception of high frequency band signals through the second low noise amplifier and the second filter.

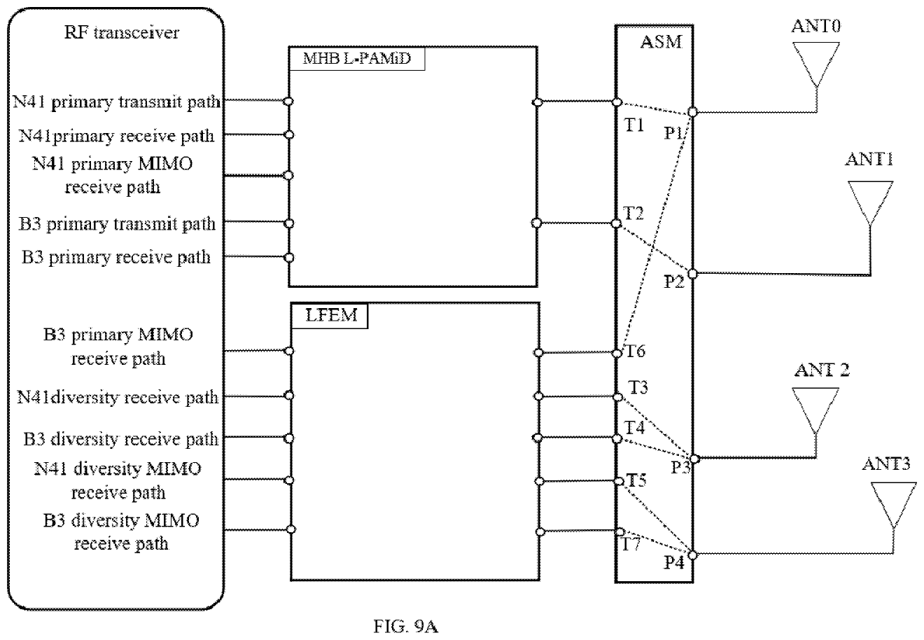

FIG. 8A is a schematic diagram of an architecture of an RF front-end system according to some embodiments of the disclosure.

The RF front-end system includes a first antenna ANT0, a second antenna ANT1, a third antenna ANT2, a fourth antenna ANT3, an RF transceiver, an antenna switching module ASM, a low noise front end module (LNA Front end Module, LFEM) and the RF front-end device (illustrated as MHB L-PAMiD in FIG. 8A) as described in any one of FIGS. 2A to 7.

The RF transceiver is connected to the first antenna via the RF front-end device and the ASM, thereby forming at least a primary transmit path for a high frequency band signal (illustrated as an N41 primary transmit path in FIG. 8) and a primary receive path for the high frequency band signal (illustrated as an N41 primary receive path in FIG. 8).

The RF transceiver is connected to the second antenna via the RF front-end device and the ASM, thereby forming at least a primary MIMO receive path for the high frequency band signal (illustrated as an N41 primary MIMO receive path in FIG. 8), a primary receive path for a middle frequency band signal (illustrated as a B3 primary receive path in FIG. 8), and a primary transmit path for the middle frequency band signal (illustrated as a B3 primary transmit path in FIG. 8).

The RF transceiver is connected to the third antenna via the LFEM and the ASM, thereby forming at least a diversity receive path for the high frequency band signal (illustrated as an N41 diversity receive path in FIG. 8) and a diversity receive path for the middle frequency band signal (illustrated as a B3 diversity receive path in the figure).

The RF transceiver is connected to the fourth antenna via the LFEM and the ASM, thereby forming at least a diversity MIMO receive path for the high frequency band signal (illustrated as an N41 diversity MIMO receive path in FIG. 8).

Specifically, the ASM may be a 4P5T switch, a first P port P1 is connected to ANT0, a second P port P2 is connected to ANT1, a third P port P3 is connected to ANT2, a fourth P port P4 is connected to ANT3. A first T port T1 is connected to the first P port P1, and is connected to a transmit port for a high frequency band signal of the RF front-end device. A second T port T2 is connected to the second P port P2, and is connected to a port of the RF front-end device that integrates high frequency band signal reception and middle frequency band signal transmission/reception. A third T port T3 is connected to the third P port P3, and is connected to a diversity receive path port for the high frequency band signal of the LFEM. A fourth T port T4 is connected to the third P port P3, and is connected to a diversity receive path port for a middle frequency band signal of the LFEM. A fifth T port T5 is connected to the fourth P port P4, and is connected to a diversity MIMO receive path port for the high frequency band signal of the LFEM.

FIG. 8B is a schematic diagram of an architecture of another RF front-end system according to some embodiments of the disclosure.

The primary transmit path for the high frequency band signal (illustrated as an N41 primary transmit path in FIG. 8B) is realized by the RF transceiver, a high frequency band power amplifier HB PA, the switch, the first filter Filter1, the ASM and the ANT0.

The primary receive path for the high frequency band signal (illustrated as an N41 primary receive path in FIG. 8B) is realized by the ANT0, the ASM, the first filter Filter1, the switch, a first high frequency band low noise amplifier HB LNA1 and the RF transceiver.

The primary MIMO receive path for the high frequency band signal (illustrated as an N41 primary MIMO receive path in FIG. 8B) is realized by the ANT1, the ASM, the second filter Filter2, a second high frequency band low noise amplifier HB LNA2 and the RF transceiver.

The diversity receive path for the high frequency band signal (illustrated as an N41 diversity receive path in FIG. 8B) is realized by the ANT2, the ASM, a third filter Filter3, a third high frequency band low noise amplifier HB LNA3 and the RF transceiver.

The diversity MIMO receive path for the high frequency band signal (illustrated as an N41 diversity MIMO receive path in FIG. 8B) is realized by the ANT3, the ASM, a fourth filter Filter4, a fourth high frequency band low noise amplifier HB LNA4 and the RF transceiver.

The primary transmit path for the middle frequency band signal (illustrated as a B3 primary transmit path in FIG. 8B) is realized by the RF transceiver, a middle frequency band power amplifier MB PA, the middle frequency band duplexer, the ASM and the ANT1.

The primary receive path for the middle frequency band signal (illustrated as a B3 primary receive path in FIG. 8B) is realized by the ANT1, the ASM, the middle frequency band duplexer, a first middle frequency band low noise amplifier MB LNA1 and the RF transceiver.

The diversity receive path for the middle frequency band signal (illustrated as a B3 diversity receive path in FIG. 8B) is realized by the ANT2, the ASM, a fifth filter Filter5, a second middle frequency band low noise amplifier MB LNA2 and the RF transceiver.

It can be seen that, in the embodiments of the disclosure, the RF transceiver system can realize transmit processing of both the middle frequency band signal and the high frequency band signal by providing only a single RF L-PAMiD device. This achieves dual connectivity with both the high frequency band signals and the middle frequency band signal, and can realize a 4*4 MIMO function for the high frequency band signal, without requiring an additional external power amplifier module supporting power amplification on the high frequency band signal. Based on the above RF transceiver system, the cost can be reduced, the integration of the device can be improved, and the area occupied by various components on the substrate in the RF system can be reduced.

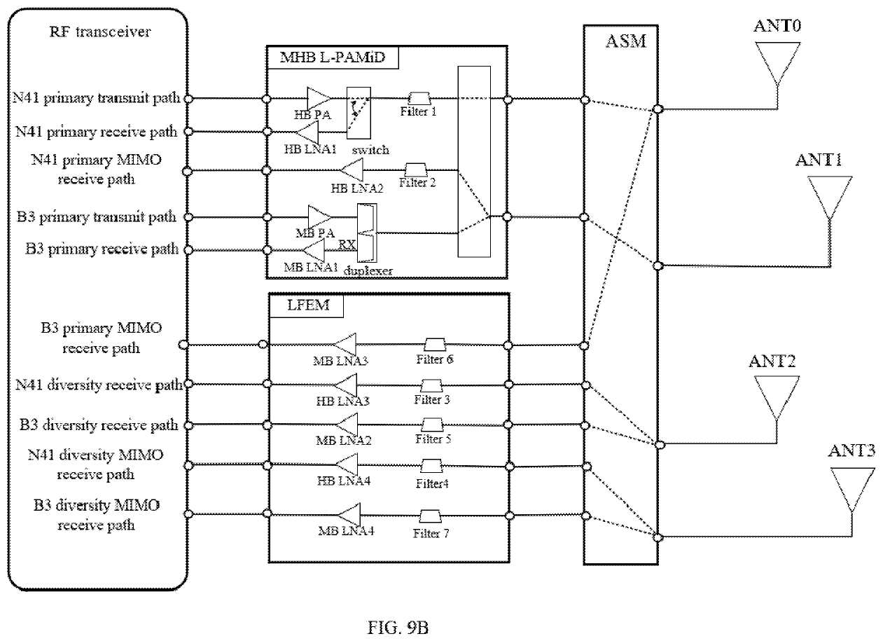

FIG. 9A is a schematic diagram of an architecture of yet another RF transceiver system according to a possible example.

The RF transceiver is connected to the first antenna ANT0 via the LFEM and the ASM, thereby forming a primary MIMO receive path for the middle frequency band signal (illustrated as a B3 primary MIMO receive path in FIG. 9A).

The RF transceiver is connected to the fourth antenna ANT3 via the LFEM and the ASM, thereby further forming a diversity MIMO receive path for the middle frequency band signal (illustrated as a B3 diversity MIMO receive path in FIG. 9A).

Specifically, the ASM may be a 4P7T switch, a first P port P1 is connected to ANT0, a second P port P2 is connected to ANT1, a third P port P3 is connected to ANT2, a fourth P port P4 is connected to ANT3. A first T port T1 is connected to the first P port P1 and is connected to a transmit port for the high frequency band signal of the RF front-end device. A second T port T2 is connected to the second P port P2, and is connected to a port of the RF front-end device that integrates high frequency band signal reception and middle frequency band signal transmission/reception. A third T port T3 is connected to the third P port P3, and is connected to a diversity receive path port for high frequency band signal of the LFEM. A fourth T port T4 is connected to the third P port P3, and is connected to a diversity receive path port for a middle frequency band signal of the LFEM. A fifth T port T5 is connected to the fourth P port P4, and is connected to a diversity MIMO receive path port for the high frequency band signal of the LFEM.

In addition, a sixth T port T6 is connected to the first P port P1, and is connected to the primary MIMO receive path port for the middle frequency band signals of the LFEM.

Further, a seventh T port T7 is connected to the fourth P port P4, and is connected to the diversity MIMO receive path port for the middle frequency band signal of the LFEM.

FIG. 9B is a schematic diagram of an architecture of still yet another RF transceiver system.

In FIG. 9B, the primary MIMO receive path for the middle frequency band signal (illustrated as a B3 primary MIMO receive path in FIG. 9B) is realized by the ANT0, the ASM, a sixth filter Filter6, a third middle frequency band low noise amplifier MB LNA3 and the RF transceiver.

In FIG. 9B, the diversity MIMO receive path for the middle frequency band signal (illustrated as a B3 diversity MIMO receive path in the figure) is realized by the ANT3, the ASM, a seventh filter Filter7, a fourth middle frequency band low noise amplifier MB LNA4 and the RF transceiver.

It can be seen that, in this example, the RF transceiver system can support a 4*4 MIMO function for the middle frequency band signal.

Some embodiments of the disclosure further provide a communication equipment, on which the RF transceiver system in any one of the above embodiments is provided. By providing the RF transceiver system on the communication equipment, since the high frequency band signal transmit path corresponding to the first transceiver circuit and the high frequency band signal receive path corresponding to the first receive circuit have no common contact in the first switch circuit, the first switch circuit can selectively perform switching between a transmit state and a receive state of the high frequency band signal without causing a problem of impedance discontinuity. As such, this can avoid the deterioration of throughput or EVM of the middle frequency band signal receive path corresponding to the second transceiver circuit, so that the high frequency band signal receive path and the middle frequency band signal receive path can both maintain the stable multi-on state to achieve CA in the receive state.

In addition, by providing only a single RF L-PAMiD device, the communication equipment can realize simultaneous transmit processing of 4G signals in any middle frequency band and 5G signals. That is, the dual connectivity with 5G band and middle frequency band 4G signals is achieved, without needing an additional external power amplifier module supporting 5G bands to amplify 5G signals. Based on the above RF transceiver system, the cost can be reduced, the integration level of devices can be improved, and the area occupied by various components on a substrate in the RF system can be reduced.

The foregoing embodiments illustrate only several implementations of this disclosure and are described in detail, which however are not to be construed as limiting the scope of this disclosure. It is notable that, for those skilled in the art, several modifications and improvements can be made without departing from the idea of this disclosure, but all of them should fall within the protection scope of this disclosure. Therefore, the protection scope of the disclosure should be subject to the appended claims.

What is claimed is:

1. A radio frequency front-end device, wherein the radio frequency front-end device is provided with a high frequency band transmit port, a first high frequency band receive port, a first middle frequency band receive port, a first antenna port, and a second antenna port; and the radio frequency front-end device at least comprises a first switch circuit, a first transceiver circuit, a first receive circuit, and a second transceiver circuit; wherein:
a plurality of first terminals of the first switch circuit are respectively connected to the first transceiver circuit, the first receive circuit, and the second transceiver circuit; a second terminal of the first switch circuit is connected to the first antenna port, and the first switch circuit is configured to selectively switch on a radio frequency path between the first transceiver circuit and the first antenna port; another second terminal of the first switch circuit is connected to the second antenna port, the first switch circuit is capable of selectively switching on a radio frequency path between the first receive circuit and the second antenna port, and the first switch circuit is further capable of selectively switching on a radio frequency path between the second transceiver circuit and the second antenna port;
the first transceiver circuit is connected to the high frequency band transmit port, and is configured to perform power amplification on a high frequency band signal from the high frequency band transmit port and output a processed high frequency band signal through the first antenna port;
the first receive circuit is connected to the first high frequency band receive port, and is configured to perform filtering and power amplification on a signal received from the second antenna port, and output a high frequency band signal to the first high frequency band receive port; and
the second transceiver circuit is connected to the first middle frequency band receive port, and is configured to perform filtering and power amplification on the signal from the second antenna port, and output a middle frequency band signal to the first middle frequency band receive port.

2. The radio frequency front-end device as claimed in claim 1, wherein the radio frequency front-end device is further provided with a middle frequency band transmit port; and
the second transceiver circuit is further connected to the middle frequency band transmit port, and is configured to perform power amplification on a middle frequency band signal from the middle frequency band transmit port and output a processed middle frequency band signal through the second antenna port.

3. The radio frequency front-end device as claimed in claim 2, wherein the second transceiver circuit comprises a middle frequency band power amplifier, a first low noise amplifier and a middle frequency band duplexer;
the middle frequency band transmit port is connected to an input terminal of the middle frequency band power amplifier, and an output terminal of the middle frequency band power amplifier is connected to a first terminal of the middle frequency band duplexer;
another first terminal of the middle frequency band duplexer is connected to an input terminal of the first low noise amplifier, and an output terminal of the first low noise amplifier is connected to the first middle frequency band receive port; and
a second terminal of the middle frequency band duplexer is connected to one first terminal of the first switch circuit.

4. The radio frequency front-end device as claimed in claim 1, wherein the radio frequency front-end device is further provided with a second high frequency band receive port; and
the first transceiver circuit is further connected to the second high frequency band receive port, and the first transceiver circuit is configured to perform filtering and power amplification on a signal received from the first antenna port, and output the high frequency band signal to the second high frequency band receive port.

5. The radio frequency front-end device as claimed in claim 4, wherein the first transceiver circuit comprises a high frequency band power amplifier, a first high frequency band low noise amplifier, a switch, and a first filter;
the high frequency band transmit port is connected to an input terminal of the high frequency band power amplifier, and an output terminal of the high frequency band power amplifier is connected to a first terminal of the switch;
another first terminal of the switch is connected to an input terminal of the first high frequency band low noise amplifier, and an output terminal of the first high frequency band low noise amplifier is connected to the second high frequency band receive port; and
a second terminal of the switch is connected to one terminal of the first filter, and another terminal of the first filter is connected to one first terminal of the first switch circuit.

6. The radio frequency front-end device as claimed in claim 1, wherein the first receive circuit comprises a second high frequency band low noise amplifier and a second filter; and
the first high frequency band receive port is connected to an output terminal of the second high frequency band low noise amplifier, an input terminal of the second high frequency band low noise amplifier is connected to a first terminal of the second filter, and a second terminal of the second filter is connected to one first terminal of the first switch circuit.

7. The radio frequency front-end device as claimed in claim 1, wherein the first switch circuit is a 2P3T switch.

8. The radio frequency front-end device as claimed in claim 1, wherein the radio frequency front-end device is a middle and high frequency band low noise amplifier-power amplifier module integrated duplexer;
the high frequency band signal is a signal of a preset high frequency band in a non-standalone mode; and
the middle frequency band signal is a signal of a preset middle frequency band in the non-standalone mode.

9. A radio frequency transceiver system, comprising:
a first antenna, a second antenna, a third antenna, a fourth antenna, a radio frequency transceiver, an antenna switching module, a low noise front end module and a radio frequency front end device;
wherein the radio frequency front-end device is provided with a high frequency band transmit port, a first high frequency band receive port, a second high frequency band receive port, a first middle frequency band receive port, a first antenna port, and a second antenna port; and the radio frequency front-end device at least comprises a first switch circuit, a first transceiver circuit, a first receive circuit, and a second transceiver circuit;
a plurality of first terminals of the first switch circuit are respectively connected to the first transceiver circuit, the first receive circuit, and the second transceiver circuit; a second terminal of the first switch circuit is connected to the first antenna port, and the first switch circuit is configured to selectively switch on a radio frequency path between the first transceiver circuit and the first antenna port; another second terminal of the first switch circuit is connected to the second antenna port, the first switch circuit is capable of selectively switching on a radio frequency path between the first receive circuit and the second antenna port, and the first switch circuit is further capable of selectively switching on a radio frequency path between the second transceiver circuit and the second antenna port;
the first transceiver circuit is connected to the high frequency band transmit port, and is configured to perform power amplification on a high frequency band signal from the high frequency band transmit port and output a processed high frequency band signal through the first antenna port; the first transceiver circuit is further connected to the second high frequency band receive port, and the first transceiver circuit is configured to perform filtering and power amplification on a signal received from the first antenna port, and output the high frequency band signal to the second high frequency band receive port; the first receive circuit is connected to the first high frequency band receive port, and is configured to perform filtering and power amplification on a signal received from the second antenna port, and output a high frequency band signal to the first high frequency band receive port; and the second transceiver circuit is connected to the first middle frequency band receive port, and is configured to perform filtering and power amplification on the signal from the second antenna port, and output a middle frequency band signal to the first middle frequency band receive port;
wherein the radio frequency transceiver is connected to the first antenna via the radio frequency front-end device and the antenna switching module, thereby forming at least a primary transmit path for a high frequency band signal and a primary receive path for the high frequency band signal;
the radio frequency transceiver is connected to the second antenna via the radio frequency front-end device and the antenna switching module, thereby forming at least a primary multiple input multiple output (MIMO) receive path for the high frequency band signal, a primary receive path for a middle frequency band signal, and a primary transmit path for the middle frequency band signal;
the radio frequency transceiver is connected to the third antenna via the low noise front-end module and the antenna switching module, thereby forming at least a diversity receive path for the high frequency band signal and a diversity receive path for the middle frequency band signal;
the radio frequency transceiver is connected with the fourth antenna via the low noise front-end module and the antenna switching module, thereby forming at least a diversity multiple input multiple output receive path for the high frequency band signal; and
the high frequency band signal is a signal of a preset high frequency band in a non-standalone mode, and the middle frequency band signal is a signal of a preset middle frequency band in the non-standalone mode.

10. The radio frequency transceiver system as claimed in claim 9, wherein:
the radio frequency transceiver is connected to the first antenna via the low noise front-end module and the antenna switching module, thereby forming a primary MIMO receive path for the middle frequency band signal; or
the radio frequency transceiver is connected to the fourth antenna via the low noise front-end module and the antenna switching module, thereby further forming a diversity MIMO receive path for the middle frequency band signal.

11. The radio frequency transceiver system as claimed in claim 9, wherein the antenna switching module is a 4P5T switch.

12. The radio frequency transceiver system as claimed in claim 9, wherein the primary transmit path for the high frequency band signal is realized by the radio frequency transceiver, a high frequency band power amplifier, a switch, a first filter, the antenna switching module and the first antenna.

13. The radio frequency transceiver system as claimed in claim 12, wherein the primary receive path for the high frequency band signal is realized by the first antenna, the antenna switching module, the first filter, the switch, a first high frequency band low noise amplifier and the radio frequency transceiver.

14. The radio frequency transceiver system as claimed in claim 9, wherein the primary MIMO receive path for the high frequency band signal is realized by the second antenna, the antenna switching module, a second filter, a second high frequency band low noise amplifier and the radio frequency transceiver.

15. The radio frequency transceiver system as claimed in claim 9, wherein the diversity receive path for the high frequency band signal is realized by the third antenna, the antenna switching module, a third filter, a third high frequency band low noise amplifier and the radio frequency transceiver.

16. The radio frequency transceiver system as claimed in claim 9, wherein the diversity MIMO receive path for the high frequency band signal is realized by the fourth antenna, the antenna switching module, a fourth filter, a fourth high frequency band low noise amplifier and the radio frequency transceiver.

17. The radio frequency transceiver system as claimed in claim 9, wherein the primary transmit path for the middle frequency band signal is realized by the radio frequency transceiver, a middle frequency band power amplifier, a middle frequency band duplexer, the antenna switching module and the second antenna.

18. The radio frequency transceiver system as claimed in claim 9, wherein the primary receive path for the middle frequency band signal is realized by the second antenna, the antenna switching module, a middle frequency band duplexer, a first middle frequency band low noise amplifier and the radio frequency transceiver.

19. The radio frequency transceiver system as claimed in claim 9, wherein the diversity receive path for the middle frequency band signal is realized by the third antenna, the antenna switching module, a fifth filter, a second middle frequency band low noise amplifier and the radio frequency transceiver.

20. A communication equipment, comprising a radio frequency transceiver system, wherein the radio frequency transceiver system comprises a first antenna, a second antenna, a third antenna, a fourth antenna, a radio frequency transceiver, an antenna switching module, a low noise front end module and a radio frequency front end device;
wherein the radio frequency front-end device is provided with a high frequency band transmit port, a first high frequency band receive port, a second high frequency band receive port, a first middle frequency band receive port, a first antenna port, and a second antenna port; and the radio frequency front-end device at least comprises a first switch circuit, a first transceiver circuit, a first receive circuit, and a second transceiver circuit;
a plurality of first terminals of the first switch circuit are respectively connected to the first transceiver circuit, the first receive circuit, and the second transceiver circuit; a second terminal of the first switch circuit is connected to the first antenna port, and the first switch circuit is configured to selectively switch on a radio frequency path between the first transceiver circuit and the first antenna port; another second terminal of the first switch circuit is connected to the second antenna port, the first switch circuit is capable of selectively switching on a radio frequency path between the first receive circuit and the second antenna port, and the first switch circuit is further capable of selectively switching on a radio frequency path between the second transceiver circuit and the second antenna port;
the first transceiver circuit is connected to the high frequency band transmit port, and is configured to perform power amplification on a high frequency band signal from the high frequency band transmit port and output a processed high frequency band signal through the first antenna port; the first transceiver circuit is further connected to the second high frequency band receive port, and the first transceiver circuit is configured to perform filtering and power amplification on a signal received from the first antenna port, and output the high frequency band signal to the second high frequency band receive port; the first receive circuit is connected to the first high frequency band receive port, and is configured to perform filtering and power amplification on a signal received from the second antenna port, and output a high frequency band signal to the first high frequency band receive port; and the second transceiver circuit is connected to the first middle frequency band receive port, and is configured to perform filtering and power amplification on the signal from the second antenna port, and output a middle frequency band signal to the first middle frequency band receive port;
the radio frequency transceiver is connected to the first antenna via the radio frequency front-end device and the antenna switching module, thereby forming at least a primary transmit path for a high frequency band signal and a primary receive path for the high frequency band signal;
the radio frequency transceiver is connected to the second antenna via the radio frequency front-end device and the antenna switching module, thereby forming at least a primary MIMO receive path for the high frequency band signal, a primary receive path for a middle frequency band signal, and a primary transmit path for the middle frequency band signal;
the radio frequency transceiver is connected to the third antenna via the low noise front-end module and the antenna switching module, thereby forming at least a diversity receive path for the high frequency band signal and a diversity receive path for the middle frequency band signal;
the radio frequency transceiver is connected with the fourth antenna via the low noise front-end module and the antenna switching module, thereby forming at least a diversity multiple input multiple output receive path for the high frequency band signal; and
the high frequency band signal is a signal of a preset high frequency band in a non-standalone mode, and the middle frequency band signal is a signal of a preset middle frequency band in the non-standalone mode.
